(19) United States
(12) Patent Application Publication
(10) Pub. No.: US 2026/0211798 A1
(43) Pub. Date: Jul. 23, 2026

(54) REAL-TIME CODE COVERAGE GENERATION WITHOUT INSTRUMENTED BUILDS

(71) Applicant: NVIDIA Corporation, Santa Clara, CA (US)

(72) Inventors: Abhishek ANURAG, Pune (IN); Rohit SINGH, Pune (IN); Abhishek SAHU, Pune (IN); Vikas BIJALWAN, Pune (IN)

(73) Assignee: NVIDIA Corporation, Santa Clara, CA (US)

(21) Appl. No.: 19/033,022

(22) Filed: Jan. 21, 2025

(51) Int. Cl. G06F 11/3668; G06F 8/36

(52) U.S. Cl. CPC G06F 11/3676; G06F 8/36

(57) ABSTRACT

In various examples, systems and methods are disclosed relating to generating code coverage reports without instrumented builds. A system can identify a set of functions identified in a source code repository. The system can generate a respective flag for each function of the set of functions that indicates the function is to be profiled. The system can execute each function of the set of functions identified in the source code repository to generate profiling data according to the flag. The system can generate, using the profiling data, a code coverage report for the source code repository.

### BACKGROUND

Code coverage in software development serves as a metric to gauge the extent to which source code is tested. Traditionally, generating code coverage reports necessitates the use of instrumented builds, where additional code is included to monitor and record the software's behavior during execution. An instrumented build can include code that monitors or tracks which parts of the code are executed, or “covered,” by tests. However, conventional approaches for generating code coverage reports are time-consuming and result in redundant code, as the instrumented build generates a separate code base with additional instructions that will not be included in final builds.

### SUMMARY

Code coverage in software development serves to gauge the extent to which source code is tested. Traditionally, generating code coverage reports necessitates the use of instrumented builds, where additional code is included to monitor and record the software's behavior during execution. An instrumented build can include code that tracks which parts of the code are executed, or “covered,” by tests. Producing such builds involves inserting specific instructions or binary data into the source files, allowing the monitoring of different lines of code during testing to determine code coverage. This approach is time-consuming and introduces inefficiencies and additional complexities, as it requires creating a separate code base for the instrumental build with additional instructions that are not included in the released software. Furthermore, conventional approaches for testing code coverage typically require specialized tools, such as the GNU Coverage Tool (GCOV), which strictly necessitate instrumented builds to function.

The techniques described herein address these issues by providing techniques to generate code coverage reports without the need for instrumented builds. The systems and methods described herein enable the generation of code coverage reports directly from the source code during runtime, thereby saving significant time and improving overall efficiency. To implement these techniques, a script, code segment, or other similar instructions can operate as a wrapper function for the runtime build of the software and various test tools and test code that operate to test corresponding software. The wrapper can use profiling functions to automatically monitor and log the coverage data of lines and functions in real-time. Upon executing the runtime build to test the software, the script uses the monitored and logged function calls to generate coverage data, which can provide a count of the number of execution events of each line and function of the code, along with indications of different lines of code that are untested or unexecuted. These techniques can be implemented using any suitable code base, including source code written in languages such as C, C++, and Python.

At least one aspect relates to one or more processors. The one or more processors can include one or more circuits. The one or more circuits can identify a set of functions identified in a source code repository. The one or more circuits can generate a respective flag for each function of the set of functions that indicates the function is to be profiled. The one or more circuits can execute each function of the set of functions identified in the source code repository to generate profiling data according to the flag. The one or more circuits can generate, using the profiling data, a code coverage report for the source code repository.

In some implementations, the one or more circuits can identify a parent class for the source code repository. In some implementations, the one or more circuits can identify the set of functions from the parent class. In some implementations, the source code repository comprises one or more of a Python file, a C file, or a C++ file. In some implementations, the one or more circuits can generate the profiling data to include a count of a number of times each line of each of the set of functions is executed. In some implementations, the one or more circuits can generate the code coverage report to include one or more indications of lines of code of the set of functions that were not executed during generation of the profiling data.

In some implementations, the one or more circuits can identify the set of functions using a library corresponding to a programming language of the source code repository. In some implementations, the one or more circuits can execute the set of functions within a wrapper function that generates the profiling data for the set of functions. In some implementations, the one or more circuits can generate the code coverage report to include an indication of an unexecuted branch of at least one function of the set of functions. In some implementations, the one or more circuits can identify at least one unexecuted function of the source code repository. In some implementations, the one or more circuits can generate an indication to update at least one test for the at least one function of the source code repository.

At least one other aspect relates to a system. The system can provide a wrapper script for generating code coverage reports for a set of source files. The system can update, using the wrapper script, the set of source code files to include profiling instructions. The system can generate profiling data for the set of source files by executing instructions of the set of source files via the wrapper script. The system can generate an indication of at least one unexecuted function of the set of source files based at least on the profiling data.

In some implementations, the system can generate a code coverage report for the set of source files based at least on the profiling data, the code coverage report to include the indication of the at least one unexecuted function. In some implementations, the system can generate the code coverage report to include an indication of a number of times each function of the set of source files is executed. In some implementations, the system can identify testing instructions associated with the at least one unexecuted function. In some implementations, the system can provide a notification indicating that the testing instructions are to be updated to execute the at least one unexecuted function. In some implementations, the set of source files correspond to a non-instrumented build.

At least one other aspect relates to a method. The method can include applying a wrapper script to a source code repository to instrument at least one source file with runtime profiling capabilities The method can include executing the at least one source file via the wrapper script to generate profiling data for at least one function associated with the source code repository. The method can include generating, using the profiling data, a code coverage report for the source code repository.

In some implementations, the method can include identifying a parent class for the source code repository. In some implementations, the method can include identifying the at least one function from the parent class. In some implementations, the source code repository comprises one or more of a Python file, a C file, or a C++ file. In some implementations, the method can include generating the profiling data to include a count of a number of times each line of each of the at least one function is executed.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing generative AI operations using a small language model, a system for performing generative AI operations using a large language model, a system for performing generative AI operations using a multi-modal language model, a system for performing generative AI operations using a vision language model, a system implemented using an edge device, a system implemented using a robot, a system for performing conversational AI operations, a system for generating synthetic data, a system incorporating one or more virtual machines (VMs), a system implemented at least partially in a data center, or a system implemented at least partially using cloud computing resources.

### BRIEF DESCRIPTION OF THE DRAWINGS

The present systems and methods for real-time code coverage generation without instrumented builds are described in detail below with reference to the attached drawing figures, wherein:

FIG. 1 is a block diagram of an example system for generating code coverage reports without instrumented builds, in accordance with some embodiments of the present disclosure;

FIG. 2 depicts an example data flow diagram showing an iterative process for updating unit tests using the techniques described herein, in accordance with some embodiments of the present disclosure;

FIG. 3 is a flow diagram of an example of a method for generating code coverage reports without instrumented builds, in accordance with some embodiments of the present disclosure;

FIG. 4 is a block diagram of an example computing device suitable for use in implementing at least some embodiments of the present disclosure; and

FIG. 5 is a block diagram of an example data center suitable for use in implementing at least some embodiments of the present disclosure.

### DETAILED DESCRIPTION

This disclosure relates to systems and methods for real-time code coverage generation without instrumented builds. Code coverage in software development serves as a metric to gauge the extent to which source code is tested. Traditionally, generating code coverage reports necessitates the use of instrumented builds. An instrumented build is a version of source code for the software where additional code has been included to monitor and record how the software behaves during execution. When testing for code coverage, an instrumented build can include code that monitors or track which parts of the code are executed, or “covered.” by tests.

Producing instrumented builds can involve inserting specific instructions or binary data into the source files of the software that is to be tested such that the execution of different lines of code can be monitored during testing to determine code coverage. Such approaches are time-consuming and result in redundant code, as the resulting instrumented build results in a separate code base with additional instructions that will not be included in the released software. Moreover, conventional approaches for testing code coverage typically require specialized tools, such as the GNU Coverage Tool (GCOV), which strictly require instrumented builds to function.

The techniques described herein address these issues by providing techniques to generate code coverage reports that circumvent the need for instrumented builds. By leveraging a wrapper on top of existing code, the techniques described herein enable the real-time generation of code coverage reports directly from the source code during runtime. These approaches obviate the need to generate an instrumented build for software, improving the efficiency of executing tests for the source code.

To implement these techniques, a script is provided that operates as a wrapper function for the runtime build of the software and various test tools and test code that operate to test the software. The wrapper script can use profiling functions to automatically monitor and log the coverage data of lines and functions in real-time. Upon executing the runtime build to test the software, the script can use the monitored and logged function calls to generate coverage data. The coverage data can provide a count of the number of execution events of each line and function of the code, along with indications of different lines of code that are untested/unexecuted. The techniques described herein can be implemented using any suitable code base, including source code written in languages such as C, C++, and Python.

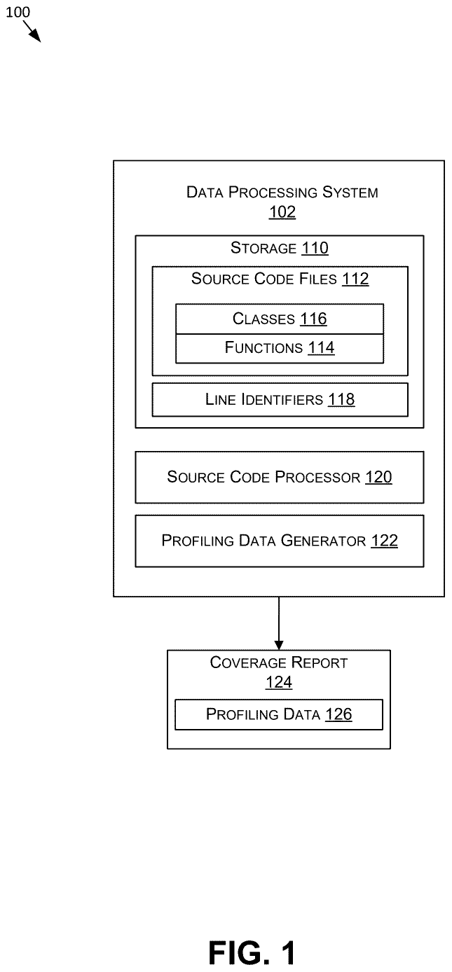

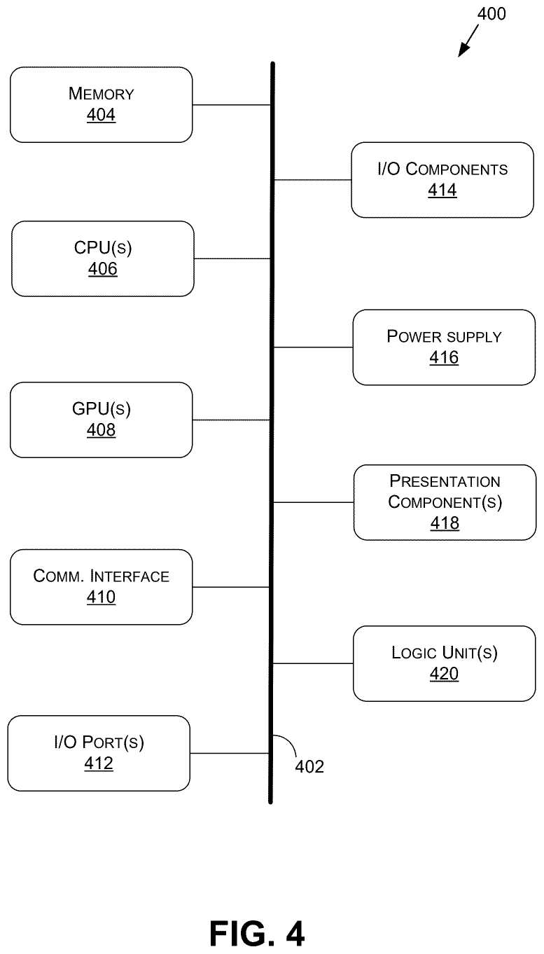

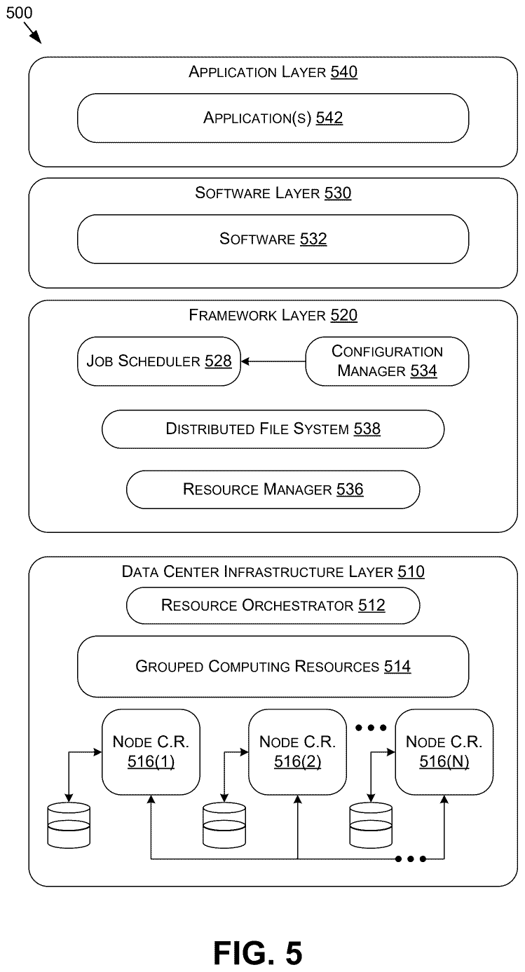

With reference to FIG. 1, FIG. 1 is an example computing environment including a system 100 for generating code coverage reports without instrumented builds, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. For example, in some embodiments, the system and methods described herein may be implemented using one or more computing devices or components thereof (e.g., as described in FIG. 4), and/or one or more data centers or components thereof (e.g., as described in FIG. 5).

The system 100 can be used to generating code coverage reports without instrumented builds. The system is shown as including a data processing system 102 and an output coverage report(s) 124. The data processing system 102 is shown as including storage 110, a source code processor 120, and a profiling data generator 122. The storage 110 may be internal or external to the data processing system 102 and can store one or more source code files 112 (e.g., as part of one or more source code repositories). The source code files 112 can include and/or specify various classes 116 and functions 114, each of may be associated with corresponding line identifiers 118. The coverage report(s) 124 is shown as including profiling data 126, which as described in further detail herein may be generated for corresponding source code file(s) 112.

The data processing system 102 can generate the coverage report(s) 124 without generation of an instrumented build for a source code repository stored in the storage 110. The data processing system 102 can store one or more source code repositories in the storage 110. The data processing system 102 can execute the source code processor 120 to process and automatically flag various classes 116 and functions 114 in corresponding source code files 112 to facilitate generation of the coverage report(s) 124 described herein. The data processing system 102 can generate profiling data 126 for each function 114 and/or class 116 specified in the source code files 112, and provide indications of which lines (e.g., identified by line identifiers 118) of source code files 112 that are executed or not executed during unit tests or other testing approaches.

The data processing system 102 can include one or more processors, circuits, memory, and/or computing devices/systems that can perform the various techniques described herein. The data processing system 102 can be implemented, for example, in a cloud computing environment, which may maintain, update, or otherwise access one or more source code repositories 112. The data processing system 102 can implement the various techniques described herein to automatically profile functions 114 and classes 116 and identify which lines of source code are executed during tests for the source code repository. The code coverage generation process executed by the data processing system 102 can be initiated in response to a request from an external computing system (e.g., a client device) in communication with the data processing system 102 and/or in response to operator input at the data processing system 102.

The data processing system 102 can access one or more source code repositories in the storage 110 to generate one or more coverage reports 124. The source code repositories can each include one or more source code files 112, are shown as being stored in the storage 110. The storage 110 may be maintained locally at the data processing system 102 or within an external storage system in communication with the data processing system 102. In some implementations, the storage 110 may be a versioned software repository that stores a record of changes of different source code files 112. In some implementations, the storage 110 may be an external server, distributed storage/computing environment (e.g., a cloud storage system), or any other type of storage device or system that is in communication with the data processing system 102. When performing the techniques described herein to generate one or more coverage reports 124, the data processing system 102 can retrieve or otherwise access source files 112. In some implementations, the source files 112 to access and/or use in connection with the techniques described herein may be specified via a request to generate the coverage report 124.

The source files 112 can be any type of source file that includes instructions or code that may be executed or compiled, including but not limited to Python, C, and C++. In some implementations, the source files 112 may be stored in a version-controlled environment, such that different versions of the source files 112 and/or a source repository corresponding thereto can be accessed by the data processing system 102. The source files 112 can include any number of functions 114, which can be blocks of code/instructions that can be used to perform specific operations. The functions 114 may be referenced/called by other code/instructions within the source files 112 to execute their corresponding operations. Operations implemented by the functions 114 can include but are not limited to processing data, performing calculations, or interacting with operating system or hardware functionality (e.g., via operating system application programming interfaces (APIs), system interrupts, etc.).

In some implementations, one or more of the source files 112 may specify one or more classes 116, each of which may include their own corresponding functions 114. The classes 116 can include constructs that encapsulate data (e.g., variables) and functions 114 into a single unit. Each class 116 can define its own set of functions 114, which can be used to manipulate the data of the class 116 and perform operations specific to that class 116. The functions 114 within a class 116 may be include operations related to the functionality of the class 116, including but not limited to initializing variables of the class 116, modifying variables of the class 116, or executing methods of the class 116. In some implementations, each class 116 and each function 114 can be identified by a line identifier 118, which can identify the line of source code in the source files 112 at which the class 116 or function 114 is defined or specified. In some implementations, the line identifier 118 may not be specified as part of the source files 112 but may be derived by the data processing system 102 (or the components thereof) by parsing/processing the source files 112.

The data processing system 102 can execute the source code processor 120 and the profiling data generator 122 to generate the code coverage report 124. The source code processor 120 and the profiling data generator 122 can each include software, hardware, or combinations of hardware and software. In some implementations, the data processing system 102 can provide the source code processor 120 and the profiling data generator 122 as a set of instructions, such as a wrapper script. In some implementations, any or all of the functionality of the data processing system 102 can be performed using the wrapper script.

In some implementations, the data processing system 102 can execute the wrapper script following integration of the wrapper script in a source code repository. For example, the wrapper script may be added/referenced in one or more build scripts such as Make files, build scripts, or configuration files, among others. In some implementations, the wrapper may be referenced such that the wrapper can be invoked as part of a build process and/or test process for the set of source files 112. For example, the data processing system 102 can provide the wrapper script such that the wrapper script can be invoked using one or more corresponding flags, configuration settings, and/or build signals to perform any of the techniques described herein.

The data processing system 102 can execute the source code processor 120 to identify a set of functions 114 in the set of source code files 112 for which the code coverage report 124 is to be generated. This may include iteratively accessing and parsing each of the source code files 112 to extract and analyze the code structure. The source code processor 120 can parse the source code files 112 to identify the set of functions 114 by identifying function definitions according to the syntax of the language of the source code files 112. Parsing the source code files 112 can include scanning the source code files 112 for specific keywords and syntax patterns that indicate the presence of functions, such as the def keyword in Python or the function declaration syntax in C and C++. In some implementations, the source code processor 120 can incorporate/use techniques such as lexical analysis and syntax tree generation to accurately identify and parse function 114 definitions and/or class 116 definitions from the source code files 112.

In some implementations, the source code processor 120 can identify the set of functions 114 using a library selected based on the programming language of the source code files 112. For example, the source code processor 120 can access language-specific libraries and/or toolsets that can parse and analyze code written in different programming languages. For example, if the source code files 112 are written in Python, the source code processor 120 can use a Python-specific library to parse the source code files 112 and/or identify the functions 114. In another example, to parse C or C++ source code files 112, the source code processor 120 can use a C or C++ parser library to extract and identify the functions 114. The source code processor 120 can dynamically select and load the corresponding library based on the programming language of the source code files 112. The programming language of the source files may be identified using any suitable technique, including but not limited to accessing a file extension of the source code files 112, identifying the programming language according to an initial parsing of the source code files and/or identifying the programming language according to configuration settings of the source code repository.

In some implementations, the source code processor 120 can identify one or more classes 116 from the source code files 112 using similar techniques. Classes 116 may include or may be associated with one or more methods (e.g., functions 114) and corresponding variables. The source code processor 120 can iterate through each of the methods of each identified class 116 to identify one or more of the set of functions 114. For example, the source code processor 120 can identify class 116 definitions and their associated functions 114 by parsing the source code files 112 for class keywords and structures, similar to the techniques described herein above. Once a class 116 is identified, the source code processor 120 can traverse the class definition to locate and extract the functions 114 defined within the class. In some implementations, the source code processor 120 can use a recursive descent parser or a context-free grammar to parse the class 116 definitions and extract corresponding functions 114, among other techniques.

In some implementations, the source code processor 120 can generate a line identifier 118 for each of the functions 114 and/or classes 116 identified during the parsing process. In some implementations, the line identifiers 118 can be stored in the memory of the data processing system 102, separate from the source code files 112, such that the data processing system 102 (or the components thereof) can identify the locations of functions in the source code files 112 in generating the code coverage report 124. The line identifiers 118 can identify the line at which the function 114 and/or class 116 is defined within the source code files 112. In some implementations, the source code processor 120 can store the line identifiers 118 as part of a mapping data structure that associates each function 114 and/or class 116 with its corresponding line identifier 118. In some implementations, the mapping data structure can be stored in a data structure such as a dictionary, a list, or any other suitable data structure.

Once functions 114 have been identified from the source code files 112, the source code processor 120 can automatically update each of the set of source files to include profiling instructions. For example, the source code processor 120 can generate a respective flag for each identified function 114 that indicates the function 114 is to be profiled during execution. The flag may be generated by directly modifying the source code files 112 and/or by modifying an instance of the source code files loaded into working memory of the data processing system 102. The source code processor 120 can access and/or modify the source code files 112 according to the line identifiers 118 or other identifiers of the functions 114. Accessing the functions 114 may include locating the specific lines of the source code files 112 where the functions 114 are defined and inserting corresponding profiling instructions.

In one example, the source code processor 120 can use the ‘setattr’ Python function to set a profiling attribute for each identified function in Python source code files 112. The setattr function allows the source code processor 120 to dynamically add or modify attributes of an object, including functions 114 identified by the source code processor 120. The source code processor 120 can use setattr to add a profiling attribute to each function 114, which can be used to track the execution of the function during runtime. This attribute can be a flag or a reference to a profiling function that logs the execution details of the function 114. In some implementations, the profiling function may be provided as part of the wrapper script and may be implemented at least in part by the profiling data generator 122, as described in further detail herein.

Similar approaches can be used to provide a flag and/or profiling instructions for each C/C++ function 114. For C/C++ source code files 112, the source code processor 120 can automatically insert profiling instructions directly into the function definitions. Inserting the flag and/or profiling instructions may include inserting one or more macros and/or one or more functions call at the beginning and/or end of each function 114 to record the execution of the function 114. Recording the execution of the function 114 may include providing instructions to track a number of times the function 114 is executed and/or the amount of time taken to execute the function 114. For example, the source code processor 120 can insert a first macro and/or profiling instructions at the beginning of each C/C++ function 114 and a second macro and/or profiling instructions at the end of each C/C++ function 114. In some implementations, only a single macro may be used to modify the C++ functions 114. As described herein, the modifications to the source code files 112 may be performed in a version of the source code files 112 loaded into memory, such that the actual source code files 112 in the source code repository are not modified. In some implementations, the source code files 112 in the source code repository may be modified.

For example, the source code processor 120 can directly modify the source code files to include profiling instructions within each function. This can involve inserting the profiling instructions at the appropriate locations within the function 114 definitions using the line identifiers 118 to identify the locations of the functions 114. In some implementations, the profiling instructions can be selected based on the programming language of the source code files 112. For example, for Python source code files 112, the source code processor 120 can use Python-specific profiling instructions, while for C/C++ source code files 112, the source code processor 120 can use C/C++-specific profiling macros or instructions.

The data processing system 102 can execute the profiling data generator 122 to generate profiling data 126 for each of the functions 114. As described herein, the profiling data generator 122 can include hardware, software, or a combination of hardware and software. The profiling data generator 122 may be included as part of a wrapper script that is to execute one or more functions 114 of the source code files 112. In some implementations, the wrapper script may be incorporated into the source code repository such that the profiling data generator 122 executes each function 114 of testing instructions for the source code files 112, which themselves invoke one or more of the functions 114 in the source code files 112. For example, the testing instructions may include unit tests or other testing scenarios that are designed to exercise the functionality of the source code files 112. In some implementations, the profiling data generator 122 can access one or more parent classes 116 of the testing instructions (which can be included as part of the source code files 112) and can automatically invoke a top-level function 114 of the testing instructions. The top-level function can proceed to execute the testing instructions to test the functionality of the source code files 112.

The profiling data generator 122 can automatically generate respective profiling data 126 for each executed function 114. For example, when a function 114 is executed, the profiling data generator 122 can automatically store the start and/or end times of execution function 114 generated by the profiling instructions or in accordance with an attribute/flag as part of the profiling data 126. In some implementations, the profiling data generator 122 can automatically track the number of times each function is executed using the profiling instructions or in accordance with the attribute/flag by incrementing a counter for a function 114 each time that function 114 is executed. In such implementations, the profiling data generator 122 can initialize a respective counter for each function identified by the source code processor 120 to zero, such that unexecuted functions 114 of the source code files 112 can be identified as described herein.

The profiling data generator 122 can generate profiling data 126 to include any suitable metric for the functions 114. The metrics to generate as part of the profiling data 126 may be specified in the profiling instructions and/or attribute/flag set for each function 114, or in configuration settings of the data processing system 102. For example, for each function 114 that is executed, the profiling data generator 122 can store the duration of each execution, which can be used to calculate metrics such as the average execution time, maximum execution time, and minimum execution time. The profiling data generator 122 can store the metrics as part of the profiling data 126. The profiling data generator 122 can update the profiling data 126 as the source code files 112 are executed.

In some implementations, the profiling data generator 122 can generate the profiling data 126 to include line identifiers 118 for each of the executed functions 114. The line identifiers 118 be to indicate the lines of the source code files 112 where the functions 114 are defined, such that the operator of the data processing system 102 can efficiently locate information corresponding to the functions 114 when accessing the profiling data 126. In some implementations, the profiling data generator 122 can generate the profiling data 126 to indicate particular classes, variables, or other parameters associated with each function 114. For example, the profiling data generator 122 can store an indication of any parent classes 116, function parameters, or locations in the source code files 112 from which each function 114 is called, among other indications, as part of the profiling data 126.

The profiling data generator 122 can generate an output coverage report 124 for the source files 112 based at least on the profiling data 126. The coverage report 124 can be a code coverage report that provides information about the extent to which the source code files 112 have been tested. The profiling data generator 122 can generate the coverage report 124 to include at least a portion of, or all of, the profiling data 126 generated during the execution of the functions 114. The coverage report 124 can be structured to present the profiling data 126 in a hierarchical format, with each function 114 and its corresponding line identifiers 118 delineated and provided with corresponding profiling data 126.

For example, the profiling data generator 122 can generate the coverage report 124 to include an indication of the number of times each function 114 was executed by the testing instructions. The profiling data generator 122 can use the profiling data 126 to identify any unexecuted functions 114. For example, after completing execution of the testing instructions, the profiling data generator 122 can iterate through the respective execution counter associated with each function 114 and identify the functions 114 having a counter value of zero. The profiling data generator 122 can generate coverage report 124 to indicate which functions 114 were not executed via the testing instructions. In some implementations, the unexecuted functions 114 can be stored in association with an indication or a notification in the coverage report 124 that indicates a location at which the unexecuted functions 114 are to be called within the source code files 112, if any. In some implementations, the coverage report 124 may include links, buttons, or other interactive elements, and/or integration with an integrated development environment, to navigate directly to the unexecuted functions 114 or classes 116 associated therewith.

In some implementations, the profiling data generator 122 can identify unexecuted branches within functions 114 and/or the testing instructions and indicate the unexecuted branches in the coverage report 124. In such implementations, the profiling data generator 122 can generate the coverage report 124 to include indications of overall branch coverage for the source files 112. To do so, the profiling data generator 122 can access the profiling data 126 to identify which functions 114 have been unexecuted. The profiling data generator 122 can parse or otherwise access the source files 112 to identify any branches where the unexecuted functions 114 are called/invoked. Branches may include, but are not limited to, conditional statements or loops, among other control structures. Any branches that include an unexecuted function 114 can be flagged within the coverage report 124 as being unexecuted. The profiling data generator 122 can perform similar techniques to indicate which branches within the source code files 112 have been executed. In some implementations, the profiling data generator 122 can generate the coverage report 124 to include an indication of a number of times a given branch has been executed, which can be determined based at least on a number of times each function 114 within a branch has been executed.

The data processing system 102 can store the coverage report 124 in association with the source code repository including the source code files 112, for example, in the memory of the data processing system 102. In some implementations, the data processing system 102 can present the coverage report 124 to an operator of the data processing system 102 via one or more display devices. In an implementation where the data processing system 102 generated the coverage report 124 in response to a request from an external computing device, the data processing system 102 can transmit the coverage report 124 to the external computing device or store the coverage report 124 in a storage repository accessible by the external computing device.

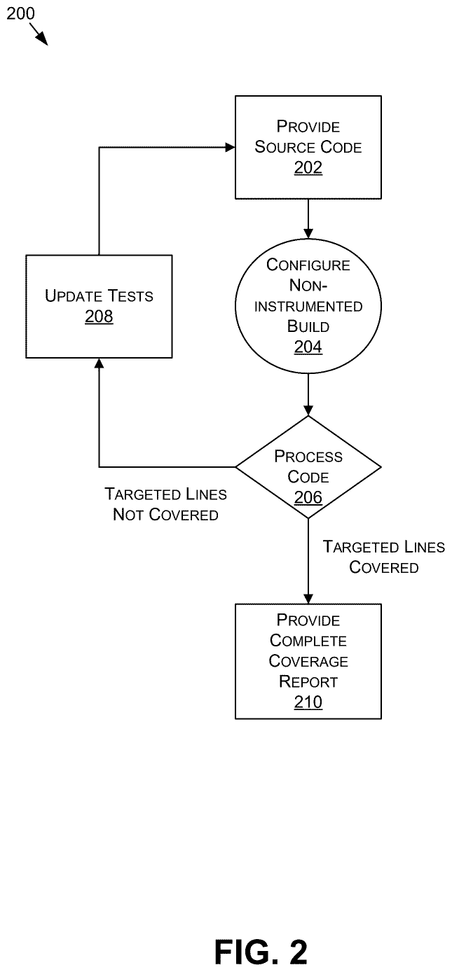

Referring to FIG. 2 in the context of the components described in connection with FIG. 1, depicted is an example data flow diagram 200 showing an iterative process for updating unit tests (e.g., testing instructions for source files 112) using the techniques described herein, in accordance with some embodiments of the present disclosure. The flow diagram 200 shows an example approach for modifying tests for a set of source code. The process can start at step 202, at which a set of source code (e.g., the source code files 112, etc.) is provided. The source code may be provided as a standalone repository, or as a set of source files specifically targeted to a testing environment. In some implementations, the source code may include any type of source code file, including but not limited to Python files, C files, or C++ files, among others.

At step 204, the source code can be configured as a non-instrumented build for testing via testing instructions (e.g., one or more unit tests, etc.). This may include invoking or configuring scripts that configure the source code as a non-instrumented build, which does not include any additional hooks or monitoring code. In some implementations, this may include modifying environment variables, build flags, and/or other configuration settings such that the source code is to be executed as a non-instrumented build. The non-instrumented build may include one or more testing instructions for the source code, which may include unit tests for various software components specified in the source code.

At step 206, the source code can be processed using a wrapper script, which may include performing any of the functionality described herein in connection with the source code processor 120. For example, the source code may automatically be modified/processed to invoke profiling instructions. The modifications may occur in working memory of the computing system testing/implementing the source code by setting attribute flags or indications of profiling instructions without modifying the source code files directly. The code can be processed using the techniques described in connection with the profiling data generator 122 to determine whether all targeted lines of code (e.g., all functions, etc.) are executed via the testing instructions for the source code, as described herein.

At step 208, if the output of step 206 indicates that not all functions of the source code are executed by the testing instructions, an operator can update the source code of the testing instructions. As described herein, profiling data 126 and/or the coverage reports 124 can indicate which functions (and corresponding branches, in some implementations) are not executed by testing instructions/testing code. This may indicate an inadequate test for those functions. These functions can be updated for the source code to cover the previously uncovered functions, and the process can begin again at step 202.

At step 210, if the output of step 206 indicates that all target functions of the source code were executed by the testing instructions, a complete coverage report can be generated as output. The complete coverage report (e.g., the coverage report 124) can include profiling data indicating the execution time and number of instances where each function of the source code is executed. In some implementations, the coverage report may indicate line numbers referencing where each function is defined in the source code and where each function is invoked within the source code/testing instructions. The complete coverage report may be presented (e.g., to an operator of the data processing system 102 via one or more display devices).

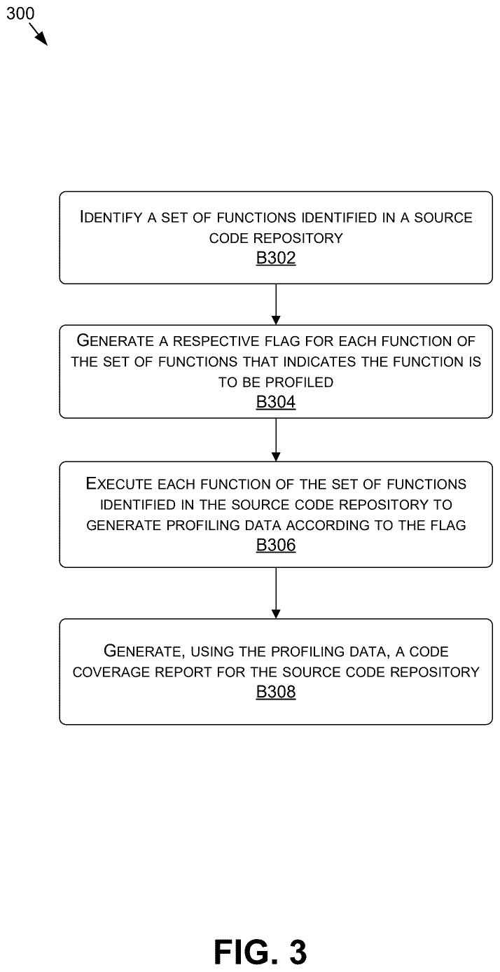

Now referring to FIG. 3, each block of method 300, described herein, includes a computing process that may be performed using any combination of hardware, firmware, and/or software. For instance, various functions may be carried out by one or more processors executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1. However, this method may additionally or alternatively be executed by any one system, or any combination of systems, including, but not limited to, those described herein.

FIG. 3 is a flow diagram showing a method 300 for generating code coverage reports without instrumented builds, in accordance with some embodiments of the present disclosure. The method 300, at block B302, can include identifying a set of functions (e.g., functions 114) identified in a source code repository. To do so, any of the functionality described in connection with the source code processor 120 of FIG. 1 may be utilized. Identifying the functions may include parsing the source code files to identify each function, including the location in the source file at which the function is defined. In some implementations, the functions may be identified as method of one or more parent classes (e.g., the classes 116, etc.), as described herein. The source code repository may include any type of source file, including but not limited to Python source files, C source files, or C++ source files, among others. In some implementations, the function(s) may be identified from the source files of the source code repository using one or more libraries specific to the source code language, as described herein.

The method 300, at block B304, can include generating a respective flag for each function of the set of functions that indicates the function is to be profiled. To do so, any of the functionality of the source code processor 120 of FIG. 1 may be performed. In an example where the source code repository includes Python files, the ‘setattr’ Python function can be used to set a flag/attribute for a function that indicates the function is to be profiled using corresponding profiling instructions. In an example where the source code repository includes C/C++ files, profiling instructions may be automatically incorporated into the functions of the source code files, which may involve providing one or more macros and/or function calls to profiling instructions for the functions of the C/C++ files.

The method 300, at block B306, can include executing each function of the set of functions identified in the source code repository to generate profiling data (e.g., the profiling data 126) according to the flag. To do so, any of the functionality described in connection with the profiling data generator 122 of FIG. 1 can be performed. As described herein, testing instructions may be provided as part of the source code repository to test one or more functions, modules, classes, or sets of files within the source code repository. In some implementations, the testing instructions can automatically be invoked to execute the set of functions (or a subset thereof). As each function has been modified with a flag and/or profiling instructions, profiling data can automatically be generated for a given function each time the function is executed. In some implementations, a respective counter for each function can be initialized prior to executing the functions, which can be incremented each time the corresponding function is executed.

The method 300, at block B308, can include generating, using the profiling data, a code coverage report for the source code repository. To do so, any of the functionality described in connection with the profiling data generator 122 of FIG. 1 can be performed. The coverage report can specify the number of times each function is executed, and in some implementations may include execution statistics for each function. In some implementations, the coverage report can indicate which functions of the source code repository were unexecuted by the testing instructions. In some implementations, the coverage report can indicate one or more unexecuted branches specified in the source code repository, as described herein. In some implementations, a the code coverage report may be visually presented via one or more display devices.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), light transport simulation (e.g., ray-tracing, path tracing, etc.), collaborative content creation for three-dimensional (3D) assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs), one or more small language models (SLMs), one or more multi-modal language models (MMLMs), one or more vision language models (VLMs), systems for performing light transport simulation, systems for performing collaborative content creation for 3D assets, systems implemented at least partially using cloud computing resources, and/or other types of systems.

### Example Computing Device

FIG. 4 is a block diagram of an example computing device(s) 400 suitable for use in implementing some embodiments of the present disclosure. Computing device 400 may include an interconnect system 402 that directly or indirectly couples the following devices: memory 404, one or more central processing units (CPUs) 406, one or more graphics processing units (GPUs) 408, a communication interface 410, input/output (I/O) ports 412, input/output components 414, a power supply 416, one or more presentation components 418 (e.g., display(s)), and one or more logic units 420. In at least one embodiment, the computing device(s) 400 may comprise one or more virtual machines (VMs), and/or any of the components thereof may comprise virtual components (e.g., virtual hardware components). For non-limiting examples, one or more of the GPUs 408 may comprise one or more vGPUs, one or more of the CPUs 406 may comprise one or more vCPUs, and/or one or more of the logic units 420 may comprise one or more virtual logic units. As such, a computing device(s) 400 may include discrete components (e.g., a full GPU dedicated to the computing device 400), virtual components (e.g., a portion of a GPU dedicated to the computing device 400), or a combination thereof.

Although the various blocks of FIG. 4 are shown as connected via the interconnect system 402 with lines, this is not intended to be limiting and is for clarity only. For example, in some embodiments, a presentation component 418, such as a display device, may be considered an I/O component 414 (e.g., if the display is a touch screen). As another example, the CPUs 406 and/or GPUs 408 may include memory (e.g., the memory 404 may be representative of a storage device in addition to the memory of the GPUs 408, the CPUs 406, and/or other components). As such, the computing device of FIG. 4 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 4.

The interconnect system 402 may represent one or more links or busses, such as an address bus, a data bus, a control bus, or a combination thereof. The interconnect system 402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 406 may be directly connected to the memory 404. Further, the CPU 406 may be directly connected to the GPU 408. Where there is direct, or point-to-point connection between components, the interconnect system 402 may include a PCIe link to carry out the connection. In these examples, a PCI bus need not be included in the computing device 400.

The memory 404 may include any of a variety of computer-readable media. The computer-readable media may be any available media that may be accessed by the computing device 400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 406 may be configured to execute at least some of the computer-readable instructions to control one or more components of the computing device 400 to perform one or more of the methods and/or processes described herein. The CPU(s) 406 may each include one or more cores (e.g., one, two, four, eight, twenty-eight, seventy-two, etc.) that are capable of handling a multitude of software threads simultaneously. The CPU(s) 406 may include any type of processor and may include different types of processors depending on the type of computing device 400 implemented (e.g., processors with fewer cores for mobile devices and processors with more cores for servers). For example, depending on the type of computing device 400, the processor may be an Advanced RISC Machines (ARM) processor implemented using Reduced Instruction Set Computing (RISC) or an x86 processor implemented using Complex Instruction Set Computing (CISC). The computing device 400 may include one or more CPUs 406 in addition to one or more microprocessors or supplementary co-processors, such as math co-processors.

In addition to or alternatively from the CPU(s) 406, the GPU(s) 408 may be configured to execute at least some of the computer-readable instructions to control one or more components of the computing device 400 to perform one or more of the methods and/or processes described herein. One or more of the GPU(s) 408 may be an integrated GPU (e.g., with one or more of the CPU(s) 406 and/or one or more of the GPU(s) 408 may be a discrete GPU. In embodiments, one or more of the GPU(s) 408 may be a coprocessor of one or more of the CPU(s) 406. The GPU(s) 408 may be used by the computing device 400 to render graphics (e.g., 3D graphics) or perform general purpose computations. For example, the GPU(s) 408 may be used for General-Purpose computing on GPUs (GPGPU). The GPU(s) 408 may include hundreds or thousands of cores that are capable of handling hundreds or thousands of software threads simultaneously. The GPU(s) 408 may generate pixel data for output images in response to rendering commands (e.g., rendering commands from the CPU(s) 406 received via a host interface). The GPU(s) 408 may include graphics memory, such as display memory, for storing pixel data or any other suitable data, such as GPGPU data. The display memory may be included as part of the memory 404. The GPU(s) 408 may include two or more GPUs operating in parallel (e.g., via a link). The link may directly connect the GPUs (e.g., using NVLINK) or may connect the GPUs through a switch (e.g., using NVSwitch). When combined together, each GPU 408 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 406 and/or the GPU(s) 408, the logic unit(s) 420 may be configured to execute at least some of the computer-readable instructions to control one or more components of the computing device 400 to perform one or more of the methods and/or processes described herein. In embodiments, the CPU(s) 406, the GPU(s) 408, and/or the logic unit(s) 420 may discretely or jointly perform any combination of the methods, processes and/or portions thereof. One or more of the logic units 420 may be part of and/or integrated in one or more of the CPU(s) 406 and/or the GPU(s) 408 and/or one or more of the logic units 420 may be discrete components or otherwise external to the CPU(s) 406 and/or the GPU(s) 408. In embodiments, one or more of the logic units 420 may be a coprocessor of one or more of the CPU(s) 406 and/or one or more of the GPU(s) 408.

Examples of the logic unit(s) 420 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 410 may include one or more receivers, transmitters, and/or transceivers that allow the computing device 400 to communicate with other computing devices via an electronic communication network, included wired and/or wireless communications. The communication interface 410 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 420 and/or communication interface 410 may include one or more data processing units (DPUs) to transmit data received over a network and/or through interconnect system 402 directly to (e.g., a memory of) one or more GPU(s) 408.

The I/O ports 412 may allow the computing device 400 to be logically coupled to other devices including the I/O components 414, the presentation component(s) 418, and/or other components, some of which may be built in to (e.g., integrated in) the computing device 400. Illustrative I/O components 414 include a microphone, mouse, keyboard, joystick, game pad, game controller, satellite dish, scanner, printer, wireless device, etc. The I/O components 414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 400. The computing device 400 may be include depth cameras, such as stereoscopic camera systems, infrared camera systems, RGB camera systems, touchscreen technology, and combinations of these, for gesture detection and recognition. Additionally, the computing device 400 may include accelerometers or gyroscopes (e.g., as part of an inertia measurement unit (IMU)) that allow detection of motion. In some examples, the output of the accelerometers or gyroscopes may be used by the computing device 400 to render immersive augmented reality or virtual reality.

The power supply 416 may include a hard-wired power supply, a battery power supply, or a combination thereof. The power supply 416 may provide power to the computing device 400 to allow the components of the computing device 400 to operate.

The presentation component(s) 418 may include a display (e.g., a monitor, a touch screen, a television screen, a heads-up-display (HUD), other display types, or a combination thereof), speakers, and/or other presentation components. The presentation component(s) 418 may receive data from other components (e.g., the GPU(s) 408, the CPU(s) 406, DPUs, etc.), and output the data (e.g., as an image, video, sound, etc.).

### Example Data Center

FIG. 5 illustrates an example data center 500 that may be used in at least one embodiments of the present disclosure. The data center 500 may include a data center infrastructure layer 510, a framework layer 520, a software layer 530, and/or an application layer 540.

As shown in FIG. 5, the data center infrastructure layer 510 may include a resource orchestrator 512, grouped computing resources 514, and node computing resources (“node C.R.s”) 516(1)-516(N), where “N” represents any whole, positive integer. In at least one embodiment, node C.R.s 516(1)-516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 516(1)-516(N) may correspond to a server having one or more of the above-mentioned computing resources. In addition, in some embodiments, the node C.R.s 516(1)-516(N) may include one or more virtual components, such as vGPUs, vCPUs, and/or the like, and/or one or more of the node C.R.s 516(1)-516(N) may correspond to a virtual machine (VM).

In at least one embodiment, grouped computing resources 514 may include separate groupings of node C.R.s 516 housed within one or more racks (not shown), or many racks housed in data centers at various geographical locations (also not shown). Separate groupings of node C.R.s 516 within grouped computing resources 514 may include grouped compute, network, memory or storage resources that may be configured or allocated to support one or more workloads. In at least one embodiment, several node C.R.s 516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 512 may configure or otherwise control one or more node C.R.s 516(1)-516(N) and/or grouped computing resources 514. In at least one embodiment, resource orchestrator 512 may include a software design infrastructure (SDI) management entity for the data center 500. The resource orchestrator 512 may include hardware, software, or some combination thereof.

In at least one embodiment, as shown in FIG. 5, framework layer 520 may include a job scheduler 528, a configuration manager 534, a resource manager 536, and/or a distributed file system 538. The framework layer 520 may include a framework to support software 532 of software layer 530 and/or one or more application(s) 542 of application layer 540. The software 532 or application(s) 542 may respectively include web-based service software or applications, such as those provided by Amazon Web Services, Google Cloud and Microsoft Azure. The framework layer 520 may be, but is not limited to, a type of free and open-source software web application framework such as Apache Spark™ (hereinafter “Spark”) that may use distributed file system 538 for large-scale data processing (e.g., “big data”). In at least one embodiment, job scheduler 528 may include a Spark driver to facilitate scheduling of workloads supported by various layers of data center 500. The configuration manager 534 may be capable of configuring different layers such as software layer 530 and framework layer 520 including Spark and distributed file system 538 for supporting large-scale data processing. The resource manager 536 may be capable of managing clustered or grouped computing resources mapped to or allocated for support of distributed file system 538 and job scheduler 528. In at least one embodiment, clustered or grouped computing resources may include grouped computing resource 514 at data center infrastructure layer 510. The resource manager 536 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 538 of framework layer 520. One or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516(N), grouped computing resources 514, and/or distributed file system 538 of framework layer 520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 534, resource manager 536, and resource orchestrator 512 may implement any number and type of self-modifying actions based on any amount and type of data acquired in any technically feasible fashion. Self-modifying actions may relieve a data center operator of data center 500 from making possibly bad configuration decisions and possibly avoiding underutilized and/or poor performing portions of a data center.

The data center 500 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 500. In at least one embodiment, trained or deployed machine learning models corresponding to one or more neural networks may be used to infer or predict information using resources described above with respect to the data center 500 by using weight parameters calculated through one or more training techniques, such as but not limited to those described herein.

In at least one embodiment, the data center 500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 400 of FIG. 4—e.g., each device may include similar components, features, and/or functionality of the computing device(s) 400. In addition, where backend devices (e.g., servers, NAS, etc.) are implemented, the backend devices may be included as part of a data center 500, an example of which is described in more detail herein with respect to FIG. 5.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 400 described herein with respect to FIG. 4. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
identify a set of functions identified in a source code repository;
generate a respective flag for each function of the set of functions that indicates the function is to be profiled;
execute each function of the set of functions identified in the source code repository to generate profiling data according to the flag; and
generate, using the profiling data, a code coverage report for the source code repository.

2. The one or more processors of claim 1, wherein the one or more circuits are to:
identify a parent class for the source code repository; and
identify the set of functions from the parent class.

3. The one or more processors of claim 1, wherein the source code repository comprises one or more of a Python file, a C file, or a C++ file.

4. The one or more processors of claim 1, wherein the one or more circuits are to:
generate the profiling data to include a count of a number of times each line of each function of the set of functions is executed.

5. The one or more processors of claim 1, wherein the one or more circuits are to:
generate the code coverage report to include one or more indications of lines of code of the set of functions that was not executed during generation of the profiling data.

6. The one or more processors of claim 1, wherein the one or more circuits are to:
identify the set of functions using a library corresponding to a programming language of the source code repository.

7. The one or more processors of claim 1, wherein the one or more circuits are to:
execute the set of functions within a wrapper function that generates the profiling data for the set of functions.

8. The one or more processors of claim 1, wherein the one or more circuits are to:
generate the code coverage report to include an indication of an unexecuted branch of at least one function of the set of functions.

9. The one or more processors of claim 1, wherein the one or more circuits are to:
identify at least one unexecuted function of the source code repository; and
generate an indication to update at least one test for the at least one function of the source code repository.

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a multi-modal language model (MMLM);
a system for performing generative AI operations using a small language model (SLM);
a system for performing generative AI operations using a large language model (LLM);
a system for performing generative AI operations using a vision language model (VLM);
a system for generating synthetic data;
a system incorporating one or more virtual machines (VMs);
a system implemented at least partially in a data center; or
a system implemented at least partially using cloud computing resources.

11. A system, comprising:
one or more processors to:
provide a wrapper script for generating code coverage reports for a set of source files;
update, using the wrapper script, the set of source code files to include profiling instructions;
generate profiling data for the set of source files by executing instruction of the set of source files via the wrapper script; and
generate an indication of at least one unexecuted function of the set of source files based at least on the profiling data.

12. The system of claim 11, wherein the one or more processor are to:
generate a code coverage report for the set of source files based at least on the profiling data, the code coverage report to include the indication of the at least one unexecuted function.

13. The system of claim 12, wherein the one or more processors are to:
generate the code coverage report to include an indication of a number of times each function of the set of source files is executed.

14. The system of claim 11, wherein the one or more processors are to:
identify testing instructions associated with the at least one unexecuted function; and
provide a notification indicating that the testing instructions are to be updated to execute the at least one unexecuted function.

15. The system of claim 11, wherein the set of source files correspond to a non-instrumented build.

16. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a multi-modal language model (MMLM);
a system for performing generative AI operations using a small language model (SLM);
a system for performing generative AI operations using a large language model (LLM);
a system for performing generative AI operations using a vision language model (VLM);
a system for generating synthetic data;
a system incorporating one or more virtual machines (VMs);
a system implemented at least partially in a data center; or
a system implemented at least partially using cloud computing resources.

17. A method, comprising:
applying, using one or more processors, a wrapper script to a source code repository to instrument at least one source file with runtime profiling capabilities;
executing, using the one or more processors, the at least one source file via the wrapper script to generate profiling data for at least one function associated with the source code repository; and
generating, using the one or more processors and the profiling data, a code coverage report for the source code repository.

18. The method of claim 17, further comprising:
identifying, using the one or more processors, a parent class for the source code repository; and
identifying, using the one or more processors, the at least one function from the parent class.

19. The method of claim 17, wherein the source code repository comprises one or more of a Python file, a C file, or a C++ file.

20. The method of claim 17, further comprising:
generating, using the one or more processors, the profiling data to include a count of a number of times each line of the at least one function is executed.
